(19) United States
(12) Patent Application Publication
(10) Pub. No.: US 2001/0026207 A1
(43) Pub. Date: Oct. 4, 2001

(54) Thermally controlled, electrical switching device

(75) Inventors: Udo Stenzel, Lichenau (DE); Robert Hemberger, Orlenbech (DE)

Correspondence Address: MERCHANT & GOULD PC, P.O. BOX 2903, MINNEAPOLIS, MN, 55402-0903, US

(73) Assignee: TSB Thermostat und Schaltgeraetebau GmbH & Co. KG

(21) Appl. No.: 09/828,583

(22) Filed: Mar. 30, 2001

(30) Foreign Application Priority Data
Mar. 31, 2000 (DE) 100 16 141.3

(51) Int. Cl. H01H 61/00; H01H 63/00; H01H 71/00; H01H 45/02; H01H 37/52

(52) U.S. Cl. 337/104; 337/333; 337/377; 337/372; 337/112; 337/365

(57) ABSTRACT

The invention relates to a thermally controlled, electrical switching device 1, which displays a bimetal element 2, an adjustment apparatus 3, and a switch-contact apparatus 6, which, on the one hand, can be adjusted by means of the bimetal element, and on the other hand, with respect to its switching point, works in conjunction with the adjustment apparatus 3. The fixed end 7 of the bimetal element 2, a fastening end 8 of the switch-contact apparatus 6, a support element 9 for the adjustment apparatus 3, and connection contact lugs 10, 11 are arranged on a carrier device 12. In order to improves the switching device 1 with respect to its mechanical characteristics and with respect to the necessary individual parts, the carrier device 12 consists of a single-piece holding block 13, formed of insulating material, with a number of essentially parallel-running reception slots 14, into which can be inserted the individual parts held by the carrier device 12, i.e. the switch-contact apparatus 6, the bimetal element 2, and the connection contacts 10, 11. The support element 9 for the adjustment apparatus 3 merges as one piece into the carrier device 12.

The invention related to a thermally controlled, electrical switching device with the features of the precharacterizing clause of claim 1.

A thermal switching device known from DE 37 35 334 C 2 displays a bimetal element, a manually operable adjustment apparatus, and a switch-contact apparatus, which on the one hand is adjustable by means of the bimetal element and, on the other hand, works together with the adjustment apparatus with respect to its switching point. A fixed end of the bimetal element, a fastening end of the switch-contact apparatus, a support element for the adjustment apparatus, and connection-contact lugs are arranged on a carrier device.

In the above-mentioned thermally controlled, electrical switching device, the support element consists of a sleeve part, onto which are threaded, as it were, by a wide margin the parts that are held by the support element. Between the electrical parts, for insulation provision is made for a central insulation sleeve surrounding the sleeve part, as well as for insulating discs, so that the structure of the collective device is complicated and requires the assembly of a number of individual parts. The support element for the adjustment apparatus is like wise specially constructed and joined to the carrier device.

The object of the invention is to further develop a thermally controlled, electrical switching device with the features of the precharacterizing clause of claim 1 in such a manner that the device comprises significantly fewer components and is more easily and quickly assembled and adjusted. This object is achieved by the fact that the carrier device consists of a single-piece holding block formed from insulating material, which block displays a number of essentially parallel-running holding slots, into which are inserted the fastening end of the switch-contact apparatus, a fixed contact support and the fixed end of the bimetal element, and the support for the adjustment apparatus merges into the carrier device as one piece.

Through the combination of features in claim 1 there results a switching device of only a few parts, so that manufacture, stockkeeping, and assembly are considerably simplified. The parts attached to the carrier device can in a simple manner be merely stuck into the reception slots or snapped into place in recesses provided in the region of the reception slots, so that the assembly is reduced to a few manipulations. A fully automatic finishing or rather equipping of the carrier device is also possible, in which case it is particularly advantageous that the parts to be attached to the carrier device are fed in their longitudinal direction, which with an automatic assembly machine is easier than feeding in the direction of the sleeve-like part, as in the case of the prior art.

Advantageously, the holding block has an essentially square cross section, and the support element for the adjustment apparatus protrudes from one end of the holding block in the manner of an L-leg. Through this structure, a high degree of stiffness between holding block and support element can be achieved, which favors the adjustment precision of the switching device. The protrusion length of the carrier device corresponds approximately to the protrusion length of the bimetal element and/or the switch-contact apparatus, so that electrical parts mounted under the support element are protected by the support element from mechanical influences.

Running between the bimetal element and the switch-contact apparatus is an elastic tongue, which merges into the holding block as one piece. This elastic tongue can serve several functions. For one thing, it can be the carrier for a one-piece transfer element that is injection-molded on, which transfers the swinging movement of the bimetal element to the protrusion end of the switch-contact apparatus. Alternatively, it is also possible to provide the elastic tongue with a guide opening on its free end, through which opening is led a transfer pin that is clamped between the swinging end of the bimetal element and the free end of the switch-contact spring.

In addition to the thus-created transfer or guide function of the elastic tongue, the latter also acts very advantageously as a heat shield between the thermally reacting bimetal element and the current conducting switch-contact apparatus, so the heat produced in consequence of the current flow cannot be transferred from the switch-contact apparatus to the bimetal element, and thereby the thermal switching point is not influenced in a negative manner.

The adjustment apparatus displays, in a manner known of itself, an adjustment spindle. According to the invention, this spindle is held in a spindle bearing that is formed as one piece with the support element; in addition, a rotation-limit stop on the adjustment spindle works in conjunction with a counter stop connected integrally with the holding block, so that additional parts can be dispensed with. The counter stop is connected in a sprung manner to the holding block in such a way that the counter stop can be deflected by the releasing of the rotational movement of the adjustment spindle. This means that the adjustment spindle can be screwed in in a particularly simple manner; with a brief pressure on the counter stop the latter is once compressed so that the rotation-limit stop can slide over this, and after the springing back of the counter stop into its target position, the counter stop can again undertake its double rotation-limit function. Through an attachment via two spring legs to the holding block, the counter stop is held securely despite the compression capability.

The bimetal element is fastened into the reception slot assigned to it by means of a snap-catch connection, for which purpose the bimetal displays at its fixed end, for the formation of the snap-catch connection, a free-stamped holding tongue bent out from the plane of the bimetal strip.

The holding block is perforated by a central opening, into which can be introduced, after the installation of the switch-contact apparatus and the connection contacts, a fastening pin, which is then ultrasound-welded or in some other way permanently fastened into the central opening.

For further stiffening of the collective structure, the end of the holding block receiving the bimetal element is connected to the protrusion end of the support element via an approximately L-shaped frame part. Resulting from this is a rectangular framework, which leads to further bracing of the support element and holding block.

Additional mechanical improvements are achieved through a framelike stiffening of the support element, provision being made on the framework in the region of the adjustment spindle for laterally protruding attachment surfaces passing integrally into the support element. The rotation-limit stop and the counter stop lie, as it were, inside the framelike stiffening and are thereby permanently protected from mechanical influences.

If the reception slots arranged in the holding block are designed so as to be open towards several sides of the holding block, then one and the same holding block can be furnished in different ways, i.e. the contact lugs, which stand out radially over the holding block, can either run parallel or protrude rectangularly or opposingly from the side surfaces of the holding block.

### In the following, the invention is explained in detail with the aid of advantageous embodiment examples in the drawn figures. These show:

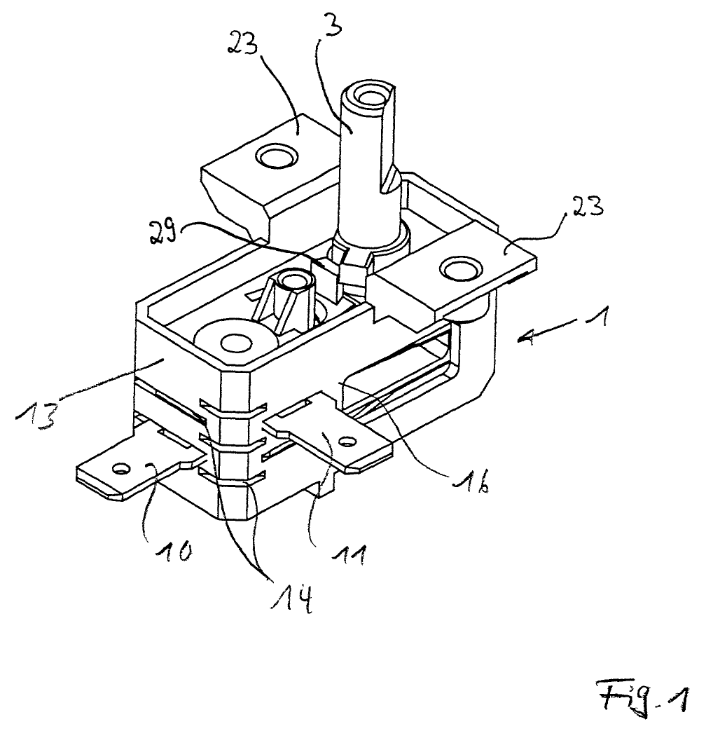

FIG. 1: a first embodiment form of a thermally controlled, electrical switching device in a first perspective view

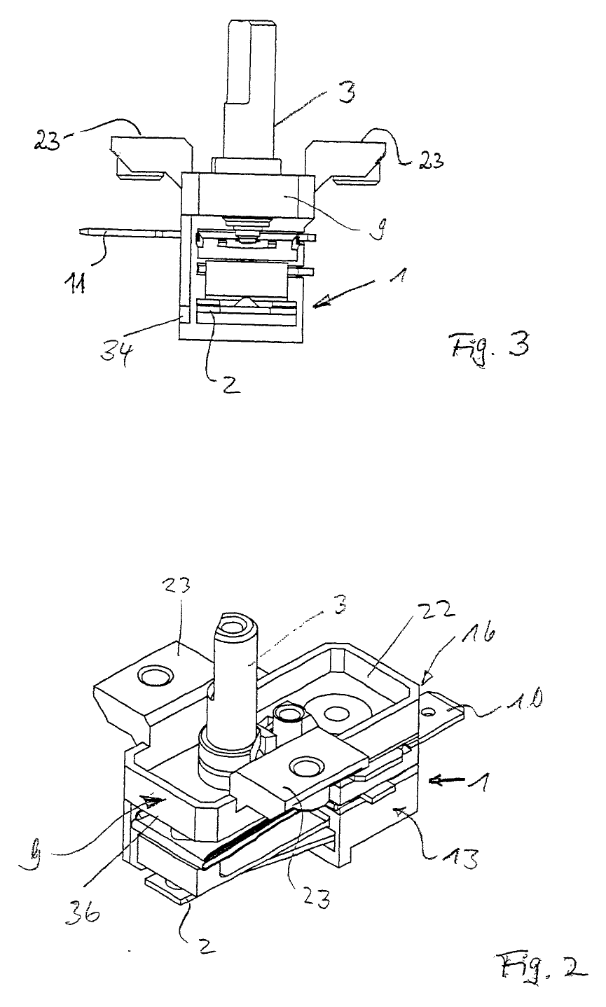

FIG. 2: a switching device according to FIG. 1 in a second perspective view

FIG. 3: a switching device according to FIG. 1 in a first side view

FIG. 4: a sectional representation through a switching device according to FIG. 1

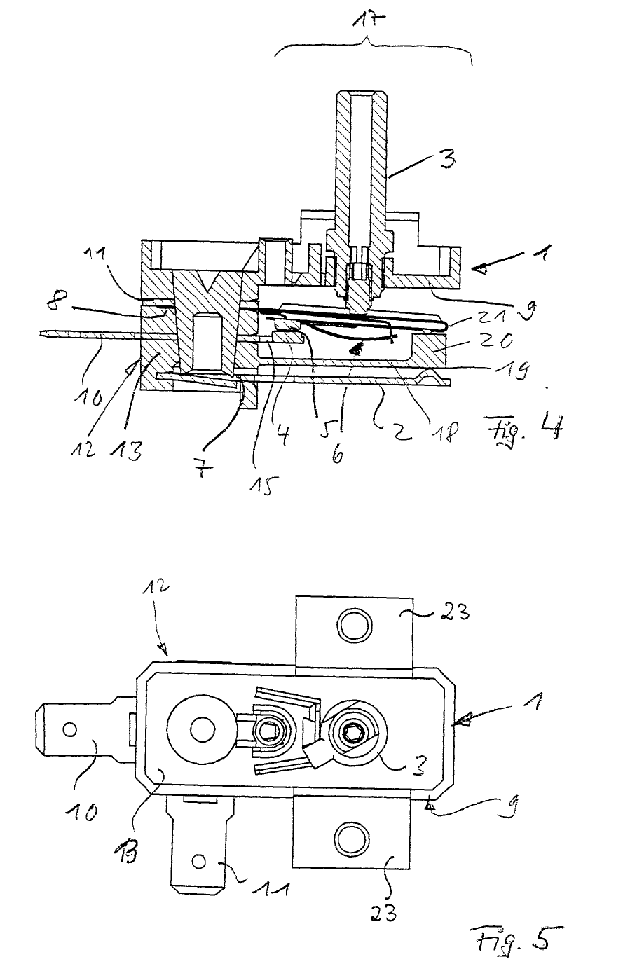

FIG. 5: a plan view of a switching device according to FIG. 1

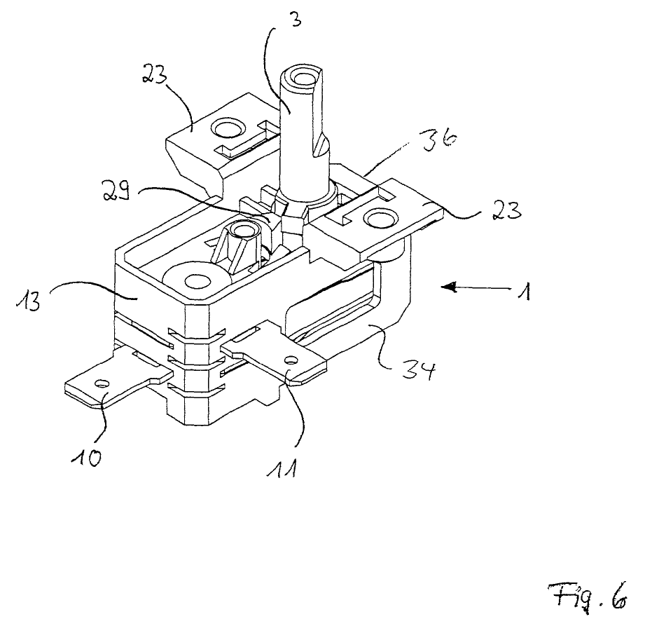

FIG. 6: an additional embodiment form of a thermally controlled, electrical switching device in a first perspective view

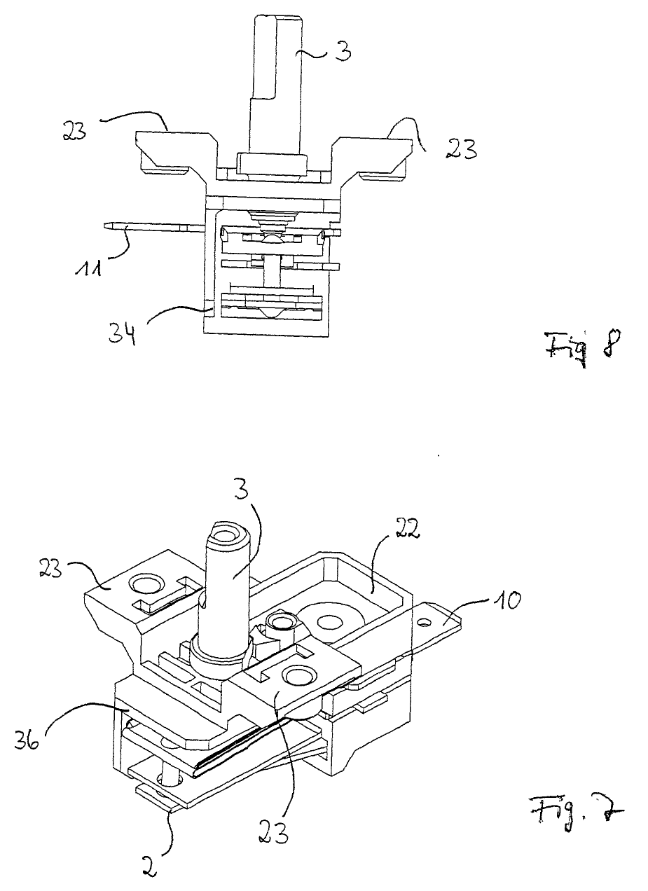

FIG. 7: a further perspective view of the switching device according to FIG. 6

FIG. 8. a side view of the switching device according to FIG. 6

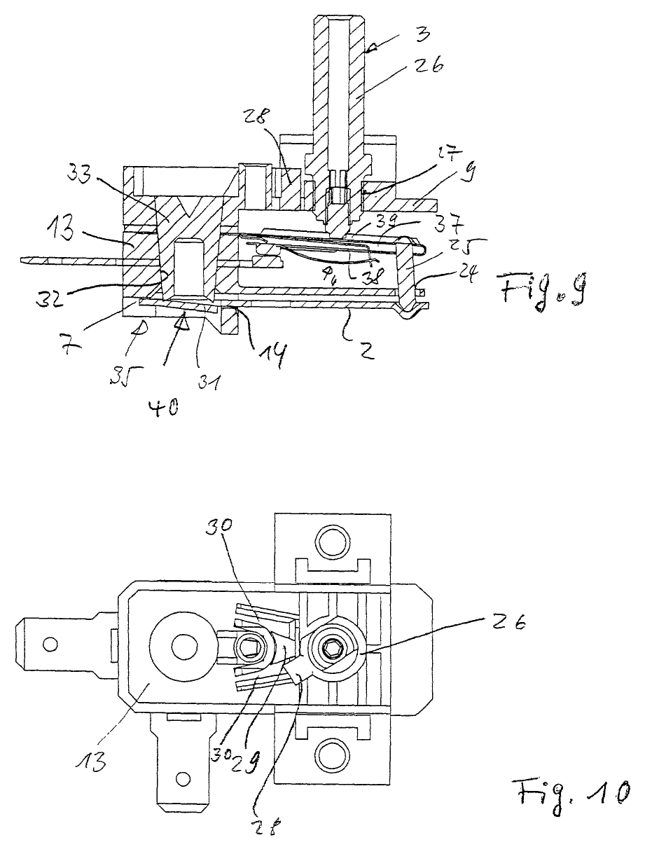

FIG. 9: a sectional representation of the switching device according to FIG. 6

FIG. 10: a plan view of the switching device according to FIG. 6

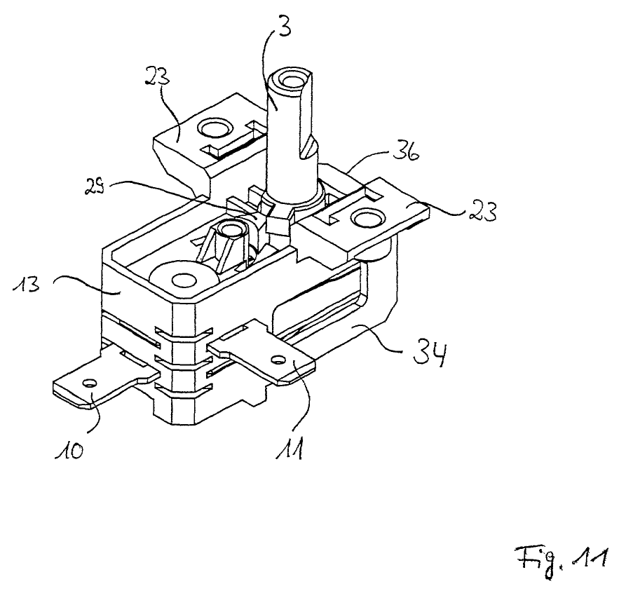

FIG. 11: a perspective view of a switching device in a third embodiment form

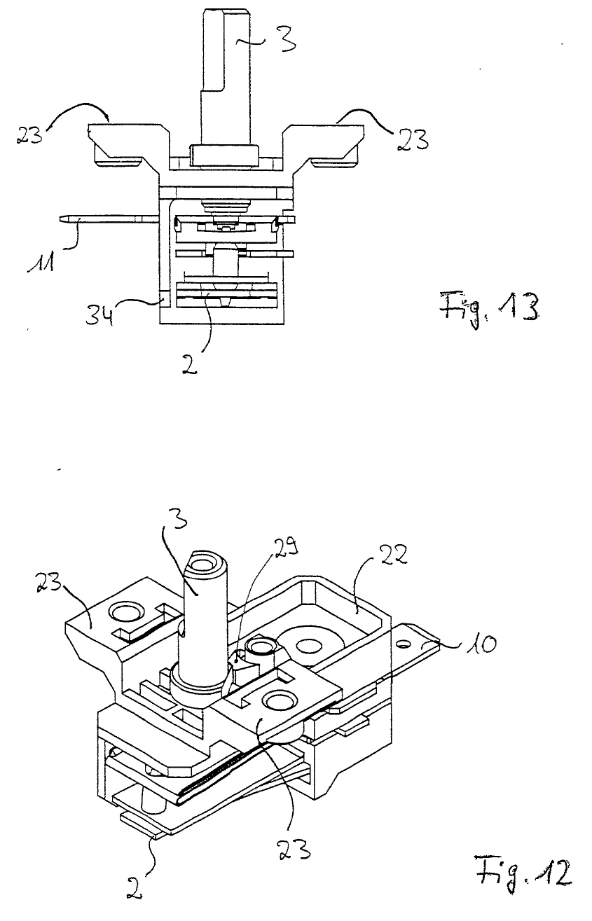

FIG. 12: a further perspective view of the switching device according to FIG. 11

FIG. 13: a side view of the switching device according to FIG. 11

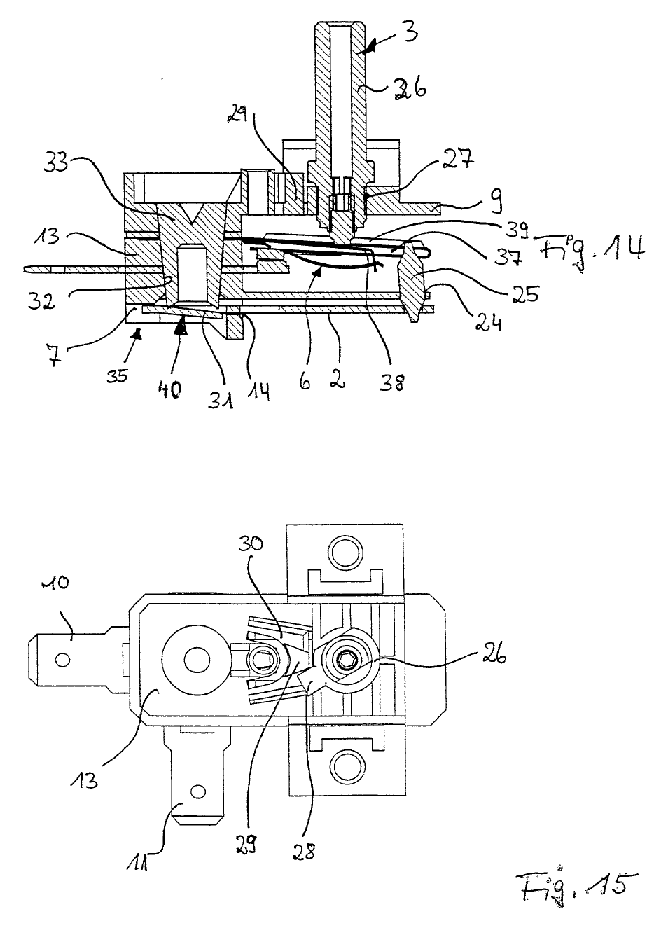

FIG. 14: a sectional representation of the switching device according to FIG. 11

FIG. 15: a plan view of the switching device according to FIG. 11

Reference is first made to drawn FIGS. 1-5, in which a thermally controlled, electrical switching device 1 in a first form of embodiment is represented. The switching device 1 displays a bimetal element 2, as well as a manually operable adjustment apparatus 3, a fixed contact 4, and a switch-contact apparatus 6 containing a moving contact 5. The switch-contact apparatus 6 is, on the one hand, adjustable via the bimetal element 2, and on the other hand the adjustment apparatus works in conjunction with the switch-contact apparatus 6 with respect to the adjustment of the switching point of the switch-contact apparatus.

A fixed end 7 of the bimetal element 2, a fastening end 8 of the switch-contact apparatus 6, a support element 9 for the adjustment apparatus 3, and connection contact lugs 10, 11 are arranged on a carrier device 12, in order to hold the respective parts mutually in position.

The carrier device 12 consists of a single-piece holding block 13 formed of insulating material, which block is provided with a number of essentially parallel-running reception slots 14, in which are inserted the fastening end 8 of the switch-contact apparatus 6, a fixed contact support 15, and the fixed end 7 of the bimetal element 2. The support element 9 for the adjustment apparatus 3 is additionally attached as one piece to the carrier device 12, or as the case may be, merges integrally into it.

The holding block 13 displays an essentially square cross section, and the support element 9 for the adjustment apparatus 3 protrudes from the end 16, illustrated at the top in the drawings, of the holding block 13 in the manner of an L-leg, the protrusion length 17 of the support element corresponding approximately to the protrusion length of the bimetal element 2 or of the switch-contact apparatus 6.

Between the bimetal element 2 and the switch-contact apparatus 6 runs an elastic tongue 18, which merges integrally into the holding block 13 and, like the latter, consists of insulating material. The elastic tongue 18 is provided at its free end 19 with a transfer element 20 injection-molded on, which transfers the swinging movement of the bimetal element 2 to the protrusion end 21 of the switch-contact apparatus 6.

The support element 9 is provided at its edge with a framelike reinforcement 22, and in addition provision is made for fastening elements 23 protruding laterally from the support element 9 and passing integrally into the latter.

In an alternative embodiment form, as represented in FIG. 6 ff, the elastic tongue 18 is provided at its free end 19 with a guide opening 24, through which is led a transfer pin 25 clamped in between the swinging end of the bimetal element 2 and the protrusion end 21 of the switch-contact apparatus 6.

In a manner known of itself, the adjustment apparatus 3 is provided with an adjustment spindle 26, which is held in a spindle bearing 27 formed as one piece with the support element 9. Injection-molded onto the adjustment spindle 26 is a rotation-limit stop 28, which works in conjunction with a counter stop 29 connected as one piece to the holding block 13. In order to enable the adjustment spindle to be screwed into the spindle bearing 27 designed as an inner thread, the counter stop 29 is connected to the holding block 13 is a sprung manner so that upon the release of the rotation movement the adjustment spindle 26 can be spring-compressed into the inside region of the holding block 13. For this purpose, the counter stop 29 is fastened to the holding block 13 by means of two spring legs 30.

In all of the represented embodiment forms, the bimetal element 2 is fastened into the reception slot 14 assigned to it by means of a snap-catch connection 40. For this purpose, the bimetal element 2 displays at its fixed end 7, for the formation of the snap-catch connection 40, a free-stamped holding tongue 31 bent out of the plane of the bimetal strip, which tongue grabs behind a counter stop in the final assembly position of the bimetal element.

The holding block 13, in all of the represented embodiment forms, is perforated by a central opening 32, into which, after the installation of the parts carried by the holding block 13, in particular the switch-contact apparatus 6 and the connection contacts, a fastening element 33 can be inserted.

Seen in drawn FIGS. 1, 3, 6, 8, 11, and 13 is an approximately L-shaped frame part 34, which joins the end 35 of the holding block 13 receiving the bimetal element 2 with the protrusion end 36 of the support element 9.

The switch-contact apparatus 6 displays, in a manner known of itself, a switch-contact spring 37, which at its free end is coupled to the swinging movement of the bimetal element 2. At its center, the switch-contact spring 37 is provided with a free-stamped spring tongue 38 forming a snap element, which spring tongue in its central region works in conjunction with the adjustment apparatus 3.

The reception slots 14 are arranged in the holding block 13 in such a manner that they permit a fastening of the connection contact lugs protruding in different directions, whereby insertion variability of the switching device is increased.

1. Thermally controlled, electrical switching device (1) with a bimetal element (2), a manually operable adjustment apparatus (3), and a switch-contact apparatus (6) comprising fixed (4) and moving (5) contacts, which switch-contact apparatus is, on the on hand, adjustable by means of the bimetal element (2), and on the other hand, with respect to its switching point works in conjunction with the adjustment apparatus (3); a fixed end (7) of the bimetal element (2), a fastening end (8) of the switch-contact apparatus (6), a support element (9) for the adjustment apparatus (3), and the connection-contact lugs (10, 11) are arranged in/on a carrier device (12), characterized by the fact that the support device (12) consists of a holding block (13) formed as a single piece of insulating material, which block displays a number of essentially parallel-running reception slots (14), in which the fastening end (8) of the switch-contact apparatus (6), a fixed-contact carrier (15), and the fixed end (7) of the bimetal element (2) are inserted, and that the carrier element for the adjustment apparatus (3) merges into the carrier device (12) as a single piece.

2. Switching device according to claim 1, characterized by the fact that the holding block (13) displays an essentially square cross section and the carrier element (9) for the adjustment apparatus (3) protrudes from one end (16) of the holding block (13) in the manner of an L-leg.

3. Switching device according to claim 1, characterized by the fact that the protrusion length (17) of the carrier element (9) corresponds approximately to the protrusion length of the bimetal element (2) and/or the switch-contact apparatus (6).

4. Switching device according to one of the previous claims, characterized by the fact that between the bimetal element (2) and the switch-contact apparatus (6) runs an elastic tongue (18), which merges as a single piece into the holding block (13).

5. Switching device according to one of the previous claims, characterized by the fact that the elastic tongue (18) displays at its free end (19) an injection-molded transfer element (20), which transfers the swinging movement of the bimetal element (2) to the protrusion end (21) of the switch-contact apparatus (6).

6. Switching device according to one of the previous claims, characterized by the fact that the elastic tongue (18) displays at its free end (19) a guide opening (24), through which is led a transfer pin (25) clamped between the swing end of the bimetal element (2) and the protrusion end (21) of the switch-contact apparatus (6).

7. Switching device according to one of the previous claims, characterized by the fact that the adjustment apparatus (3) displays an adjustment spindle (26), which is held in a spindle bearing (27) formed as one piece with the carrier element (9).

8. Switching device according to one of the previous claims, characterized by the fact that arranged on the adjustment spindle (26) is a rotation-limit stop (28), which works in conjunction with a counter stop (29) that is connected to the holding block (13) as a single piece.

9. Switching device according to one of the previous claims, characterized by the fact that the counter stop (29) is connect to the holding block (13) in a sprung manner in such a way that with the release of the rotational movement the adjustment spindle (26) can be sprung in.

10. Switching device according to one of the previous claims, characterized by the fact that the counter stop (29) is fastened to the holding block (13) by means of two spring legs (30).

11. Switching device according to one of the previous claims, characterized by the fact that the bimetal element (2) is fastened into the reception slot (14) assigned to it by means of a snap-catch connection (40).

12. Switching device according to claim 11, characterized by the fact that the bimetal (2) displays at its fixed end (7), for formation of the snap-catch connection (40), a free-stamped holding tongue (31) bent out of the plane of the bimetal strip.

13. Switching device according to one of the previous claims, characterized by the fact that the holding block (13) is perforated by a central opening (32) into which, after the installation of the switch-contact apparatus (6) and the connection contacts, a fastening element (33) can be inserted.

14. Switching device according to one of the previous claims, characterized by the fact that the end (35) of the holding block (13) receiving the bimetal element (2) is connected to the protrusion end (36) of the carrier element (9) v i a an approximately L-shaped frame part (34).

15. Switching device according to one of the previous claims, characterized by the fact that the switch-contact apparatus (6) displays a switch-contact spring (37), which at its free end is coupled to the swinging movement of the bimetal element (2) and at its center displays a free-stamped spring tongue (38) forming a snap element, which spring tongue in its center region (39) works in conjunction with the adjustment apparatus (3).

16. Switching device according to one of the previous claims, characterized by the fact that the carrier element (9) at its edge displays a framelike reinforcement (22).

17. Switching device according to one of the previous claims, characterized by the fact that the carrier element (9) displays in the region of the adjustment spindle laterally protruding fastening surfaces (23) that pass into the carrier element (9) as one piece.

18. Switching device according to one of the previous claims, characterized by the fact that the reception slots (14) arranged in the holding block (13) are open towards several different sides of holding block (13).

19. Switching device according to one of the previous claims, characterized by the fact that the holding slot (14) receiving the bimetal element (2) is open towards the front end of the holding block (13).
